(19) United States
(12) Patent Application Publication
(10) Pub. No.: US 2006/0284445 A1
(43) Pub. Date: Dec. 21, 2006

(54) Method and apparatus for washing convertible automobile without damaging the convertible top

(75) Inventor: Robert B. Eveleigh, Naples, FL (US)

Correspondence Address: ICE MILLER LLP, ONE AMERICAN SQUARE, SUITE 3100, INDIANAPOLIS, IN, 46282-0200, US

(73) Assignee: Magarl, LLC

(21) Appl. No.: 11/454,369

(22) Filed: Jun. 16, 2006

Related U.S. Application Data
(60) Provisional application No. 60/691,082, filed on Jun. 16, 2005.

(51) Int. Cl. B60J 7/20

(52) U.S. Cl. 296/136.07

(57) ABSTRACT

A method and apparatus for protecting a convertible top of an automobile from damage during an automated or powered car wash, wherein a water-resistant material configured to cover the convertible top is positioned over the external portion of the convertible top prior to washing the automobile.

### CLAIM OF PRIORITY

This application claims priority to U.S. Provisional Patent Application No. 60/691082 and entitled METHOD AND APPARATUS FOR WASHING CONVERTIBLE AUTOMOBILE WITHOUT DAMAGING THE CONVERTIBLE TOP, filed Jun. 16, 2005.

### BACKGROUND

Due to the nature and characteristics of the materials used in automobile convertible tops, a convertible top is susceptible to damage from several sources, including harsh detergents, excessively hot or cold water, and high pressure spray that are commonplace in commercial car washes. Furthermore, household car care practice presents similar susceptibility to such damage. High pressure spray, such as those found in pressurized wands or sprayers in both automated and manual car wash equipment can cause infiltration, abrasion, staining, or even tearing of the convertible top material, resulting in damage to the convertible top, reducing the value of the car or requiring replacement of the convertible top. Harsh detergents and excessively hot water can accelerate the aging of the convertible top material, or may cause discoloration of the convertible top material with an adverse effect on the automobile's value. Further, hard water can leave mineral deposits or stains on the convertible top, which can reduce the value of the automobile. In addition, there exist a variety of other actions or materials common to car wash practices which are potentially damaging to automobile convertible tops.

In order to prevent the above-mentioned adverse effects of damaging materials or circumstances, owners, detailers, and manufacturers of convertible automobiles typically recommend against or refuse the use of automated or mechanically powered systems for washing a convertible automobile. Instead, convertible automobiles are manually washed, using, if any, soap having very mild characteristics suitable for use with the convertible top while the remainder of the car is hand washed with a general purpose automobile detergent. This approach results in increased time spent washing a vehicle, increased cost, and reduced opportunity of service locations to owners of convertible automobiles, because hand washing is performed by relatively few car wash businesses and is performed at a higher cost to the owner of a convertible automobile. Therefore, a method and apparatus to protect a convertible automobile top while washing the convertible automobile in conventional, mechanically powered, and/or automated car wash systems is useful.

Further, while efforts have been made to create various apparatuses that protect a car generally, or to protect a convertible top from the elements for an extended period of time, each of apparatuses are created with substantial design elements designed specifically for a particular car model. For example, U.S. Pat. No. 4,799,728 relates to a vehicle cover designed to fit over a particular sized cab, and utilizing straps and J-hooks to secure the cover to the car body. Similarly, U.S. Pat. No. 4,863,210 relates to a cover for covering the cab of a motor vehicle and made of a flexible material sized to cover the front and back windshields, and including flaps for securing the cover between the door frame and the door on either side of the cab when the doors are locked. However, each of these disclosed inventions are directed toward covering the entire cab of a vehicle, including the front windshield, and each contain attachment and design elements that require modification of the cover to fit a given cab, depending on the vehicle model being covered. These requirements add cost to manufacturing the covers, and require a user to find a cover that is properly configured for the vehicle. Further, these existing covers cover the front windshield of a vehicle, requiring hand washing of the windshield—one of the areas most likely to be dirty—after the car is washed and the cover removed. Therefore, an apparatus and method for protecting a convertible top while washing the car that is inexpensive to manufacture, potentially disposable, and adaptable to many different car models would be greatly appreciated.

### SUMMARY

According to one aspect of the present invention, an apparatus for protecting the convertible top of an automobile during the process of washing the automobile comprises a cover configured and appropriately sized to span the width of the convertible top as well as the length of the convertible top so that the cover overlies at least a majority of the convertible top during the car wash processing. Illustratively, according to this aspect of the present invention, the convertible top protection apparatus may further comprise a structure such as a flexible sheet, a sleeve, or a sleeve having a first end open and second end sealed.

Further illustratively, according to this aspect of the invention, the protective cover may be comprised of a polymer which is flexible enough to facilitate the packaging and/or storage of a plurality of covers.

Further illustratively, according to this aspect of the invention, a plurality of the covers may be manufactured as a continuous sheet, sleeve, or film such that each individual cover is cut, torn, or otherwise separated to length from the continuous sheet or tube.

According to another aspect of the present invention, a method of protecting a convertible top of an automobile during the process of washing the automobile comprises the steps of positioning a cover configured to substantially overlie the external portion of the convertible top, so that the convertible top is substantially enveloped by the cover, and pinching the cover between the convertible top and an adjacent frame member of the automobile.

According to another aspect of the present invention, a method for protecting a convertible top during the process of washing the automobile comprises the step of manufacturing a cover to cover at least a majority of the external portion of the convertible top so that the cover is sized to substantially cover either a specific or a plurality of models of convertible automobile tops. Illustratively according to this aspect of the present invention, there exists a further step of packaging a plurality of the covers in a single container. Further illustratively, according to this aspect of the invention, a method for protecting a convertible top during the process of washing the automobile may further comprise the step of providing either one or a plurality of the covers to an entity or person that will use the cover or covers as an automobile convertible top protection apparatus.

According to another aspect of the present invention, a method for protecting a convertible automobile top during the process of washing an automobile comprises the steps of obtaining a cover configured to overlie at least a majority of the external portion of a convertible top and positioning the cover so that the cover substantially envelops at least a majority of the external portion of the convertible top.

According to another aspect of the present invention, an apparatus for protecting a convertible top of an automobile during the process of washing the automobile comprising a water resistant material of a length greater than the distance from the front of the convertible top to the back of the convertible top and of a width greater than the width of the convertible top configured to substantially envelop at least a majority of the external portion of the convertible top.

Illustratively of this aspect of the invention, the water resistant material further comprises a fastener for attaching the water resistant material to the convertible top or automobile, such that the fastener may be a hook and loop, snap, velcro, hook and eye, tacky adhesive, or any other suitable fastening device.

The above brief description sets forth rather broadly the more important features of the present invention with the intention that the following detailed description may be better understood, and the present contributions to the art may be better appreciated. There are, of course, additional features of the invention that will be described hereinafter and which will be for the subject matter of the claims appended hereto.

Those skilled in the art will appreciate that the conception, upon which the disclosure is based, may be readily utilized as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

With reference to the drawings, a new method and apparatus for washing a convertible automobile without damaging the convertible top embodying the principles and concepts of the present invention will be described.

FIG. 1 shows a perspective view of an automobile having a convertible top, in which the convertible top in its partially (partially retracted) position.

FIG. 2. shows a perspective view of a convertible automobile on which a cover is being positioned over the convertible top in such a manner that the external portion of the convertible top substantially covered by the material.

FIG. 3. shows a perspective view of the method and apparatus depicted in FIGS. 2, 5, and 6 in which the cover has been positioned to substantially cover and envelop the external portion of the convertible top, and where the convertible top has been returned to its fully extended position.

FIG. 4 shows a perspective view of an automobile having a convertible top further depicting the embodiment of FIG. 2.

FIG. 5 shows a perspective view of another embodiment of a method and apparatus covered by the present invention in which a cover comprising sleeve has been positioned over the convertible top in such a manner that both the internal and external portions of the convertible top are substantially covered.

FIG. 6 shows a perspective view of another embodiment of a method and apparatus covered by the present invention in which a sleeve having one end open and the opposite end sealed has been positioned over the convertible top such that both the internal and external portions of the convertible top are substantially covered.

FIG. 7 shows a perspective view of one embodiment of a method and apparatus covered by the present invention in which a plurality of covers comprising the structure of a sleeve having one end open and one end sealed are attached to one another.

FIG. 8 shows a perspective view of one embodiment of a method and apparatus covered by the present invention in which a plurality of covers comprising the structure of a sleeve are connected to one another.

FIG. 9 shows a perspective view of one embodiment of a method and apparatus covered by the present invention in which a plurality of covers comprising the structure of a sheet are created and dispensed.

### DETAILED DESCRIPTION

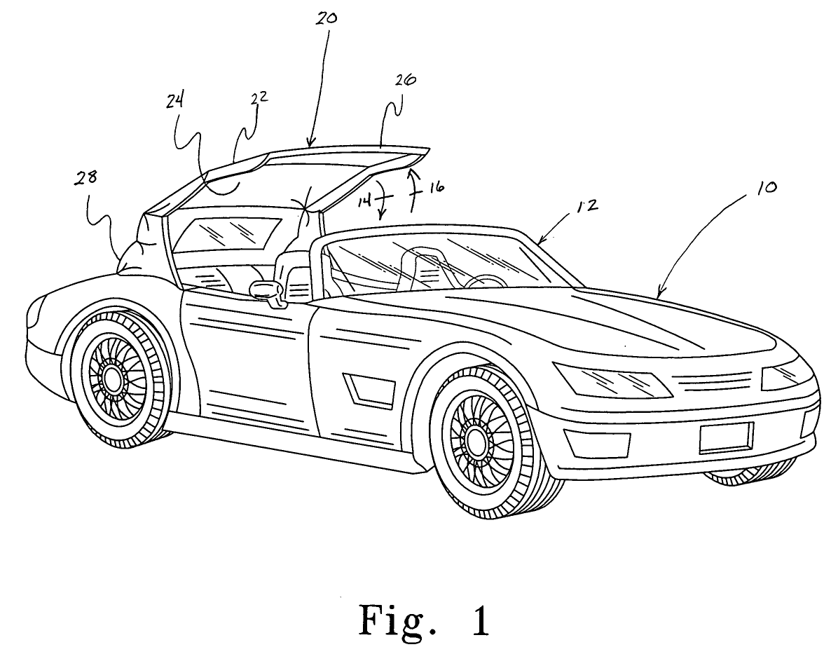

In order to understand the embodiments of the present invention, it is important to understand the workings and relevant portions of a convertible automobile. FIG. 1 shows an example of a convertible automobile (10) having a convertible top (20) in a partially extended (or partially retracted) position. With regards to the convertible top (20), there exists an internal portion (24) which generally faces inward (14) and an external portion which generally faces a substantially opposite direction (16). In addition, the convertible top (20) generally has a forward portion (26) which typically abuts and fastens to a frame member (12), and a rear portion (28) which is typically attached to an adjacent member of the automobile. Certainly, other configurations and embodiments of a convertible automobile and a convertible top exist, but the general concepts involved and shown are generally applicable.

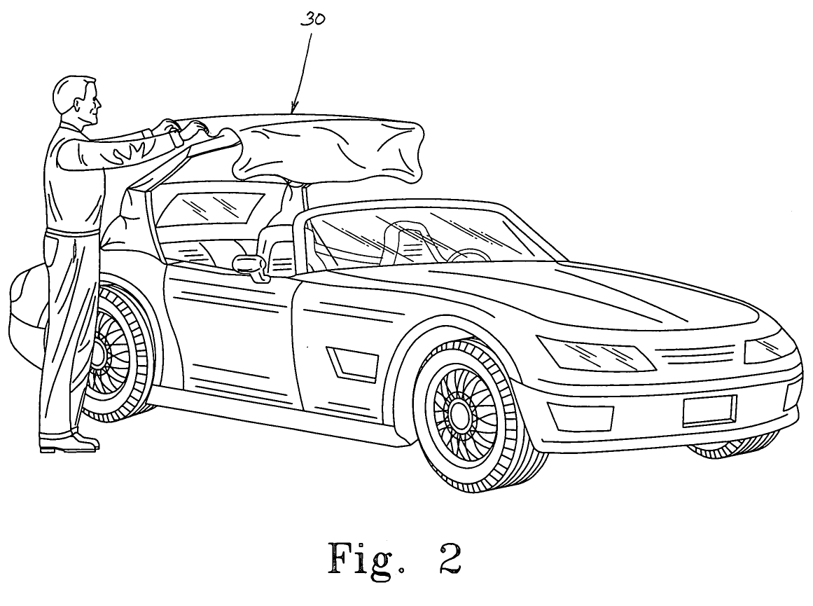

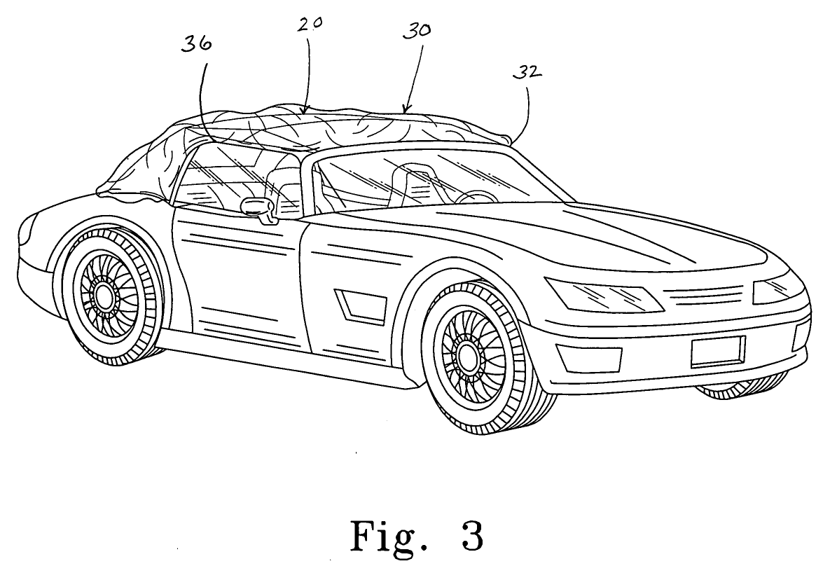

Turning now to descriptions and exemplary embodiments of the present invention, FIG. 2 shows one exemplary embodiment of a method and apparatus covered by the present invention, wherein an individual positions a cover (30) comprising a sheet of water-resistant or water-proof material over the convertible top so that a majority of the external portion of the convertible top is substantially protected. As shown in FIG. 2, it is preferable to position the cover so that a portion of the cover will drape over the forward portion (26) of the convertible top and will be pinched between the forward portion and the frame member (12) when the convertible top is in its extended position (as depicted in FIG. 3).

As shown in FIG. 3, the cover (30) is preferably positioned so that a majority of the convertible top (20) is enveloped by the cover (30), and the cover is further pinched between the convertible top (20) and adjacent automobile members such as a side window or frame member for retaining a side window (36) and a frame member for retaining a windshield (12). Additionally, FIG. 3 depicts a preferable use and application of the exemplary embodiments of the method and apparatus, including those of FIGS. 2, 5, and 6. As herein depicted, it is preferable that all exemplary embodiments of the apparatus are positioned so that the cover overlays the convertible top, and is further preferable that the cover is manipulated so that the cover is pinched between the convertible top and all adjacent portions of the automobile. By pinching the cover as described herein and depicted in FIG. 3, the external portion of the convertible top is substantially enveloped so that the convertible top is substantially protected from water, soaps, detergents, high pressure spray, and other harmful elements.

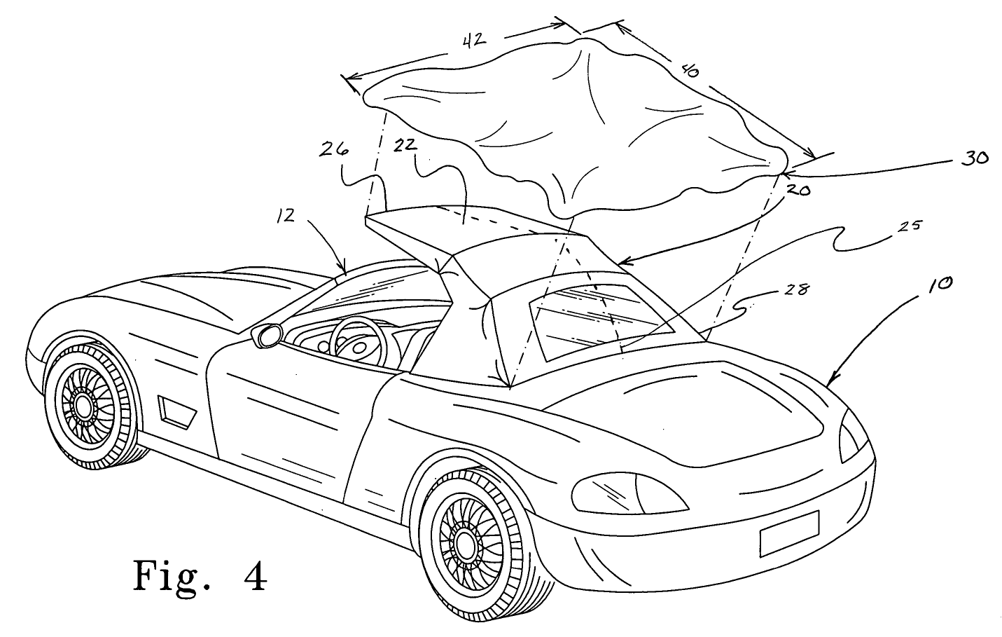

FIG. 4 displays many of the attributes and structures shown in FIGS. 1-3, but further displays them from an opposite perspective. Furthermore, one exemplary embodiment of a cover (30) comprising a water-resistant or water-proof sheet is shown in a fashion which indicates some considerations for sizing the cover. In particular, it is noted that it is preferable to have the cover sized so that the width (42) is wider than all corresponding widths of the convertible top (20) so that at least a majority of the convertible top is overlaid or enveloped when the cover (30) is applied (as depicted in FIG. 3). Additionally, the length (40) of the cover should preferably exceed the length of the convertible top when extended as measured along its generally longitudinal centerline (25) so that one end the cover may be pulled over the forward portion (26) of the convertible top while the opposite end of the cover overlies or envelops the rear portion (28) of the convertible top.

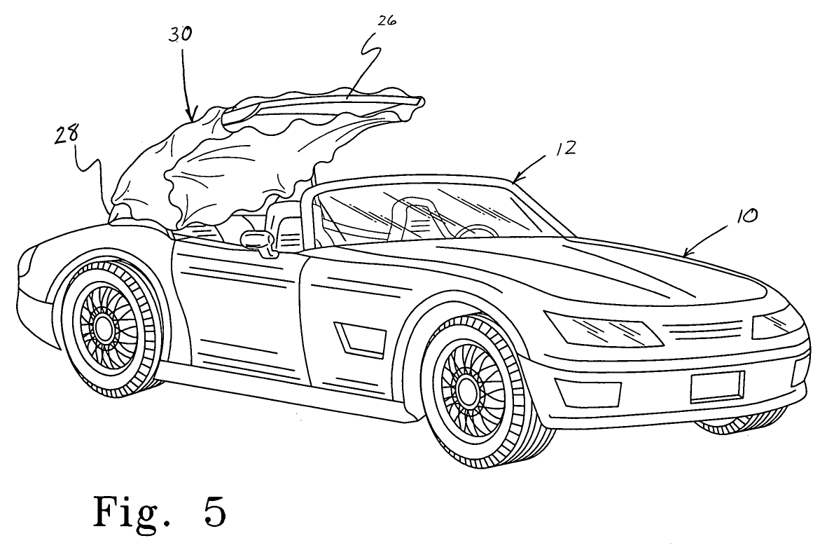

FIG. 5 further displays another exemplary embodiment of a cover comprising a sleeve of water-resistant or water-proof material which has been positioned to substantially envelop both the interior (24) and exterior (22) portions of the convertible top (20). While the forward (26) and rear (28) portions of the convertible top are visible for clarity of the illustration, it is preferable that the length (40) of the cover (30) should allow the front and rear portions of the cover to substantially overlie the forward (26) and rear (28) portions of the convertible top, respectively, when the top is extended (as depicted in FIG. 3). Additionally, it is preferable to pinch the excess of the front end of the cover (30) between the forward portion of the convertible top and the adjacent frame member (12) when the convertible top is fully extended so that the convertible top is substantially enveloped (as depicted in FIG. 3).

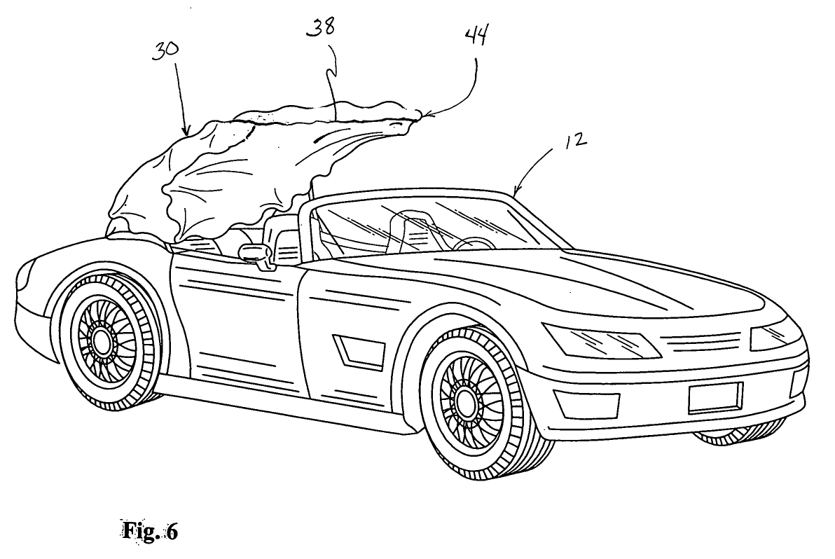

FIG. 6 shows yet another exemplary embodiment of the method of utilizing a cover comprising a sleeve of water-resistant or water-proof material having one end open and one end closed (or sealed) (44), which has been positioned to substantially envelop both the interior (24) and exterior (22) portions of the convertible top (20). As is depicted in FIG. 6, the distance from the sealed end to the open end of the cover (30) is preferably sized to exceed the distance from the forward portion (26) to the rear portion (28) of the convertible top along the longitudinal axis (25). Additionally, the sealed end of the cover (44) is preferably placed so that the seam (38) lies near the forward portion of the convertible top (20) so that the seam is pinched between the frame member (usually consisting of a frame member for retaining a windshield) (12) and the forward portion of the convertible top.

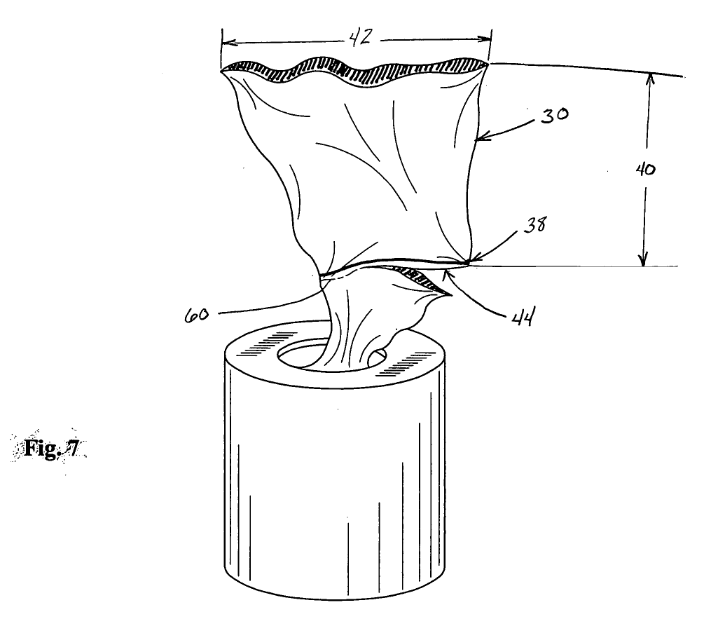

FIG. 7 depicts one exemplary embodiment of the present invention in which a cover (30) is connected to a plurality of other covers for ease of manufacturing, storage, transport, and/or dispensing. In particular, the exemplary embodiment displayed herein consists of a plurality of covers comprising a structure of a flexible sleeve having one end open and a second end sealed. In this case, the second end is sealed by means of a seam (38), and the plurality of covers can be separated to appropriate length by tearing cutting, or otherwise separating the individual cover from other covers. As is indicated by the perforations (60), it is preferable in some applications to have the connected covers perforated at regular intervals corresponding to a distance greater than the length of the convertible top (40) (as described in FIG. 4) between the perforations. The regular perforations enable the covers to be cut to length precisely without use of other tools or measuring devices. However, in utilizing such an embodiment, care should preferably be taken to ensure that the convertible top to be protected does not have a length greater than the distance between the perforation (60) and at least one seam (46). Finally, it is preferable that the width (42) of the cover should exceed the width of the convertible cover as depicted in FIG. 4 and described above.

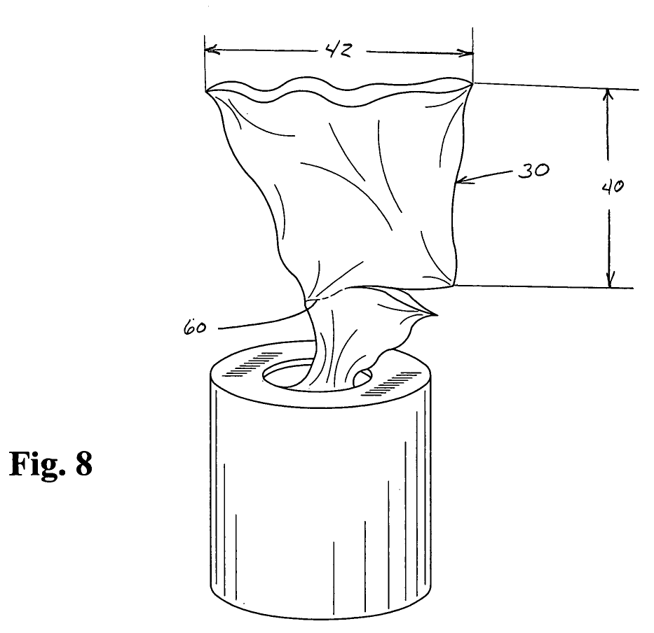

FIG. 8 depicts one exemplary embodiment of the present invention in which a cover (30) is connected to a plurality of other covers for ease of manufacturing, storage, transport, and/or dispensing. In particular, the exemplary embodiment displayed herein consists of a plurality of covers comprising a structure of a flexible sleeve. The plurality of covers can be separated to appropriate length by tearing, cutting, or otherwise separating the individual cover from other covers. As is indicated by the perforations (60), it is preferable in some applications to have the connected covers perforated at regular intervals corresponding to a distance greater than the length of the convertible top (40) (as described in FIG. 4) between the perforations. The regular perforations enable the covers to be cut to length precisely without use of other tools or measuring devices. However, in utilizing such an embodiment, care should preferably be taken to ensure that the convertible top to be protected does not have a length greater than the distance between a first perforation (60) and a second perforation so that the cover is capable of enveloping or overlaying both the forward portion (26) and rear portion (28) of the convertible top in its extended position (as depicted in FIG. 3). Finally, it is preferable that the width (42) of the cover should exceed the width of the convertible cover as depicted in FIG. 4 and described above.

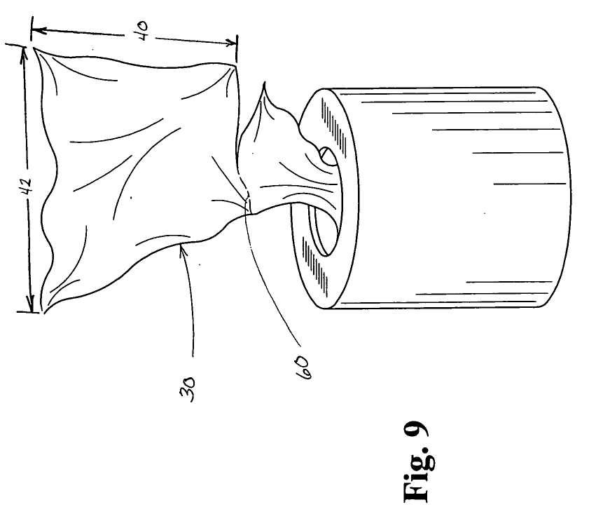

FIG. 9 depicts one exemplary embodiment of the present invention in which a cover (30) is connected to a plurality of other covers for ease of manufacturing, storage, transport, and/or dispensing. In particular, the exemplary embodiment displayed herein consists of a plurality of covers comprising a structure of a flexible sheet. The plurality of covers can be separated to appropriate length by tearing, cutting, or otherwise separating the individual cover from other covers. As is indicated by the perforations (60), it is preferable in some applications to have the connected covers perforated at regular intervals corresponding to a distance greater than the length of the convertible top (40) (as described in FIG. 4) between the perforations. The regular perforations enable the covers to be cut to length precisely without use of other tools or measuring devices. However, in utilizing such an embodiment, care should preferably be taken to ensure that the convertible top to be protected does not have a length greater than the distance between a first perforation (60) and a second perforation so that the cover is capable of enveloping or overlaying both the forward portion (26) and rear portion (28) of the convertible top in its extended position (as depicted in FIG. 3). Finally, the width of the cover (42) should preferably exceed the width of the convertible cover as depicted in FIG. 4 and described above.

As indicated by the several figures described above, the apparatus for protecting a convertible top during a car wash process has several embodiments which substantially protect a majority of the convertible top during the car wash process. Preferably, the convertible top protection apparatus substantially covers a majority of the external portion of the convertible top with a cover (30) comprising a structure of water-resistant or water-proof material (a material which resists or prevents the infiltration of water and/or water-soluble chemicals) in a manner which envelops the external portion of the convertible top (as embodied in FIG. 3) so that the external portion of the convertible top is protected from high pressure spray, temperature extremes, chemicals and/or detergents used in the car wash process.

Furthermore, in the preferred embodiment, the water resistant material or cover used to envelop the external portion of the convertible top is composed of a polymer, although it is known that other materials such as canvas or other tight woven, water-resistant, or treated cloth, molded polymers, wax-coated paper, cellophane or other cellulose films, rubber, or latex could also be used. Additionally, other suitable materials will be obvious to one of ordinary skill in the art. The use of a polymer film allows for the simplified manufacturing, packaging, and dispensing of a plurality of the embodiment, and allows this embodiment to be disposable after use. Moreover, the preferred embodiment of the water resistant material or cover takes the form of a flexible sleeve having a first end open and a second end sealed, sized and shaped so that the convertible top can fit into the open end of the sleeve and the open end of the sleeve can be pulled from the forward portion (26) of the convertible top to the rear portion (28) of the convertible top (20). See FIG. 6. However, it is known that the water resistant material or cover can take the form of a sheet (see FIGS. 2, 4), a sleeve with both ends open (see FIG. 5), a flexible tube, or a hard molded top of a geometry substantially similar to the shape of the convertible top. Additionally, other suitable forms will be obvious to one of ordinary skill in the art.

Furthermore, fasteners may be used to attach the convertible top protection apparatus to the automobile or the convertible top. This may be accomplished in many ways, including utilizing an adhesive on the edges of the cover so that the cover seals itself to the convertible top or to portions of the automobile near the convertible top. Moreover, it is easily envisioned that a cover might be secured utilizing hook and loop or a similar fastening device to secure one edge of a cover to another in a manner that causes tension to secure the cover to the convertible top. Yet another method of fastening a cover to the convertible top or to the automobile would include utilizing an elastic band in such a way that the band or strap encircles the cover and the convertible top to secure the cover to the convertible top. It can be seen that a myriad of different fasteners may be utilized in countless numbers of ways to fasten the cover to the convertible top in such a way that the cover substantially covers the convertible top and protects it from damaging elements.

Turning generally to the method of protecting an automobile convertible top during the car wash process, the method has numerous embodiments, which preferably involve covering a majority of the external portion of the convertible top with a protective material prior to washing the car. In one preferred embodiment, the convertible top is manipulated so that the front of the convertible top is released from the adjoining frame member. See FIG. 2. Thereafter, a convertible top protection apparatus or other protective material is positioned over the convertible top so that a majority of the external portion of the convertible top is covered by the protective material. Next, the convertible top is placed in its extended position, preferably with attention being made that the protective material envelops the external portion of the convertible top such that the protective material is pinched between the internal portion of the convertible top and an adjacent member of the automobile when possible. However, it is known that similar, although less effective, results can be accomplished through simply draping the protective material over the convertible top, or by merely pinching portions of the protective material between the convertible top and adjacent automobile member.

What is claimed is:

1. An automobile convertible top protection apparatus for use in washing a convertible automobile having a convertible top, wherein the convertible top has an internal portion generally facing the interior of the car and a generally opposite external portion, the apparatus comprising:
a cover comprising a flexible material and having a length greater than the distance from the front of the convertible top to the back of the convertible top and of a width greater than the width of the convertible top, the cover configured to substantially envelop at least a majority of the external portion of the convertible top when the cover is placed over the convertible top when the convertible top is fully extended, and wherein the cover does not cover a substantial portion of a front windshield of the automobile.

2. The apparatus of claim 1, wherein the cover does not comprise a mechanical fastener for securing the cover to the automobile.

3. The apparatus of claim 1, wherein the cover comprises a flexible sleeve having a substantially tubular shape, the cover having an inside portion and outside portion, the cover further sized and shaped such that the diameter of the inside portion of the cover is at least as wide as the width of the convertible top, and a length at least as great as the distance from the front of the convertible top to the back of the convertible top.

4. The apparatus of claim 2, wherein the cover is coupled to a plurality of other covers connected together to form a continuous roll so that each individual cover is cut, tom, or otherwise separated to length from the roll.

5. The apparatus of claim 4, wherein the plurality of connected covers arc perforated in a manner such that one cover separates from an adjacent cover by tearing along the perforation.

6. The apparatus of claim 1, wherein the cover further comprises a structure that is a flexible sleeve having a first end open and a second end sealed.

7. The apparatus of claim 2, wherein the cover further comprises a structure that is a flexible sleeve having a first end open and a second end sealed.

8. The apparatus of claim 8, wherein the cover is coupled to a plurality of other covers connected together so that each individual cover is cut, torn, or otherwise separated to length from the other covers.

9. The apparatus of claim 8, wherein the plurality of connected covers are perforated so that one cover separates from an adjacent cover by tearing along the perforation.

10. The apparatus of claim 9, wherein the plurality of connected covers are formed into a roll.

14. The apparatus of claim 1, further comprising a polymer.

15. A method for protecting a convertible automobile top during the process of washing an automobile wherein the convertible top has an internal portion generally facing the interior of the car and a generally opposite external portion, comprising the steps of:
a. providing a cover comprising a flexible material having a substantially tubular shape, the cover having an inside portion and outside portion, the cover further sized and shaped such that the diameter of the inside portion of the cover is at least as wide as the width of the convertible top, and a length at least as great as the distance from the front of the convertible top to the back of the convertible top;
b. positioning the cover over the convertible top so that the cover substantially overlays the external portion of the convertible top;
c. positioning a portion of the cover between the convertible top and a portion of the automobile so that when the convertible top is extended, the cover is pinched between the portion of the automobile and an adjacent portion of the convertible top; and
d. washing the automobile.

16. The method of claim 15 wherein the step of positioning a portion of the cover between the convertible top and a portion of the automobile comprises positioning a portion of the cover between the convertible top and a frame member for retaining a window or a windshield.

17. An automobile convertible top protection apparatus for use in washing a convertible automobile having a convertible top, wherein the convertible top has an internal portion generally facing the interior of the car and a generally opposite external portion, the apparatus comprising:
a cover comprising a flexible material and having a substantially tubular shape, wherein a first end is substantially sealed and a second end is substantially open, and wherein the length of the cover is greater than the distance from the front of the convertible top to the back of the convertible top, and the inside diameter of the cover is at least as large as the width of the convertible top; and
whereby the cover is operable to substantially envelop at least a majority of the external portion of the convertible top when the cover is placed over the convertible top when the convertible top is fully extended, and wherein the cover does not cover a substantial portion of a front windshield of the automobile.

18. The apparatus of claim 17, wherein the cover does not comprise a mechanical fastener for securing the cover to the automobile.

19. The apparatus of claim 17, wherein the cover further comprises a plastic polymer.

20. The apparatus of claim 17, wherein the cover further comprises a fastener for securing the cover to the rear portion of the convertible top.
